(19) United States
(12) Patent Application Publication
(10) Pub. No.: US 2024/0143984 A1
(43) Pub. Date: May 2, 2024

(54) SYSTEM FOR CREATING A TEMPORAL PREDICTIVE MODEL

(71) Applicant: CVS Pharmacy, Inc., Woonsocket, RI (US)

(72) Inventors: David Rimshnick, Roslyn, NY (US); Grigoriy Koytiger, Woonsocket, RI (US); Joshua Hug, Woonsocket, RI (US)

(21) Appl. No.: 18/491,261

(22) Filed: Oct. 20, 2023

Related U.S. Application Data
(60) Provisional application No. 63/420,017, filed on Oct. 27, 2022.

(51) Int. Cl. G06N 3/049; G06N 3/0455; G06N 3/0499; G06N 3/09

(52) U.S. Cl. CPC G06N 3/049; G06N 3/0455; G06N 3/0499; G06N 3/09

(57) ABSTRACT

A system is provided including a data pipeline and a model pipeline. A data pipeline includes: an input that receives a first dataset representing categorical features and a second dataset representing numerical features; a feature ingestion block that generates an output corresponding to a sum of the first dataset with the second dataset; an output that provides training labels based on a processing of the summed datasets to predict a temporally isolated and discrete event; and a label creation block that receives the output and generates labels for date features in the first dataset. A model pipeline includes a neural network(s) that: receives a first input corresponding to a summation of non learned date embedding with learned feature embedding; and contextualizes the summation by date embedding historical patient data into the summation. The model pipeline includes a prediction block that receives the contextualized summation and predicts one or more outcomes.

### CROSS REFERENCE TO RELATED APPLICATIONS

The present application claims the benefit of and priority to U.S. Provisional Application No. 63/420,017, filed on Oct. 27, 2022, entitled SYSTEM FOR CREATING A TEMPORAL PREDICTIVE MODEL,” which application is incorporated herein by reference in its entirety.

### FIELD OF THE DISCLOSURE

The disclosure relates to systems and methods for predictive models, and more particularly, Artificial Intelligence (AI) based systems and methods for creating a temporal predictive model.

### BACKGROUND

Pharmaceutical manufacturers, healthcare providers, pharmaceutical distributors, and other entities may employ predictive models to predict outcomes of individuals. Improved techniques for predicting the outcomes are desired.

### SUMMARY

A data pipeline includes: an input that receives a first dataset representing categorical features and a second dataset representing numerical features; a feature ingestion block that generates an output corresponding to a sum of the first dataset with the second dataset; and an output that provides training labels based on a processing of the summed first dataset and second dataset to predict a temporally isolated and discrete event.

In some aspects, the data pipeline includes a label creation block that receives the output from the feature ingestion block and generates labels for date features in the first dataset.

In some aspects, the second dataset is discretized prior to being summed with the first dataset; and discretizing the second dataset includes converting numerical features of the second dataset into categorical features.

In some aspects: the first dataset includes categorical features from clinical data; and the second dataset includes numerical features from the clinical data.

In some aspects, a model is used to predict the training labels.

In some aspects: the model includes a temporal axis and is configured to process discrete time steps; and the training labels correspond to specific time steps in the discrete time steps, time windows associated with one or more of the specific time steps, or both.

A model pipeline includes one or more neural networks that: receive a first input corresponding to a summation of non learned date embedding with learned feature embedding; and contextualize the summation of the non learned date embedding with the learned feature embedding by date embedding historical patient data into the summation of the non learned date embedding with the learned feature embedding. The model pipeline includes a prediction block that receives the contextualized summation of the non learned date embedding with the learned feature embedding and predicts one or more outcomes.

In some aspects, the one or more neural networks include at least a feed forward neural network that receives the first input.

In some aspects, the one or more neural networks include at least a causal transformer neural network that contextualizes the summation of the non learned date embedding with the learned feature embedding.

In some aspects, the one or more neural networks maintain a temporal ordering of data associated with the contextualized summation of the non-learned date embedding with the learned feature embedding.

In some aspects: the non learned date embedding includes feature dates with embedded dates; and the learned feature embedding includes feature codes with embedded features.

In some aspects: the one or more outcomes include a plurality of outcomes; and each of the plurality of outcomes has a different probability of likelihood.

In some aspects, the one or more outcomes include a clinical outcome.

In some aspects, the one or more outcomes include a retail outcome.

In some aspects, the one or more outcomes include a temporal event.

A method includes: receiving a first input at a model building system, wherein the first input includes patient data; receiving a second input at the model building system, wherein the second input includes medical claims data; receiving a third input at the model building system, wherein the third input includes third party data; enabling the model building system to leverage the first input, the second input, and the third input as part of building a prediction model for processing additional data from an entity that did not provide the patient data or the medical claims data; and providing the prediction model to a prediction system that receives customer data and that feeds the customer data to the prediction model, wherein the prediction model is enabled to predict an outcome for a discrete date based on processing the customer data.

In some aspects, the predicted outcome includes a temporal aspect.

A system includes: a model building system; and a prediction system. The model building system is to: receive a first input including patient data; receive a second input including medical claims data; receive a third input including third party data; leverage the first input, the second input, and the third input as part of building a prediction model for processing additional data from an entity that did not provide the patient data or the medical claims data; and provide the prediction model to the prediction system. The prediction system is to: feed customer data to the prediction model; and predict an outcome for a discrete date based on processing the customer data using the prediction model.

In some aspects, the model-building system is to provide training labels to the prediction system; and the prediction system is to evaluate the prediction model based on the outcome, using the training labels

In some aspects, the prediction system is to: contextualize the customer data according to a temporal parameter; and feed the contextualized customer data to the prediction model. In some aspects, predicting the outcome for the discrete date is based on processing the contextualized customer data using the prediction model.

All examples and features mentioned above can be combined in any technically possible way.

### BRIEF DESCRIPTION OF THE DRAWINGS

The present disclosure is described in conjunction with the appended figures, which are not necessarily drawn to scale:

FIG. 1 illustrates an example of a system in accordance with aspects of the present disclosure.

FIG. 2 illustrates an example of a data pipeline in accordance with aspects of the present disclosure.

FIG. 3 illustrates an example of a model pipeline in accordance with aspects of the present disclosure.

FIG. 4 illustrates an example of a user interface in accordance with aspects of the present disclosure.

FIGS. 5 through 7 illustrates example process flows in accordance with aspects of the present disclosure.

### DETAILED DESCRIPTION

Before any examples of the disclosure are explained in detail, it is to be understood that the disclosure is not limited in its application to the details of construction and the arrangement of components set forth in the following description or illustrated in the following drawings. The disclosure is capable of other configurations and of being practiced or of being carried out in various ways. Also, it is to be understood that the phraseology and terminology used herein is for the purpose of description and should not be regarded as limiting.

While various examples will be described in connection with using predictive models to predict clinical outcomes, it should be appreciated that the disclosure is not so limited. For instance, it is contemplated that examples of the present disclosure can be applied to predicting retail outcomes (e.g., retail store sales) as well as clinical outcomes (e.g., costs associated with a clinical outcome).

Example medical conditions associated with clinical outcomes include diabetes, cardiac conditions, heightened cholesterol, heightened blood pressure, hypertension, post-operative conditions, pre-operative conditions, cancer and other chronic conditions, infertility, chronic pain, broken bones, torn ligaments, torn muscles, and the like, and are not limited thereto. In other words, the framework described herein of predictive models for predicting outcomes can be leveraged to support clinical outcome prediction in association with any type or number of different medical conditions.

The terms “member,” “patient,” “individual,” and “subject” may be used interchangeably herein. The terms “care gap” or “gap-in-care” may be used interchangeably herein. The terms “lab value” and “measured biomarker value” may be used interchangeably herein.

Some clinical assessment techniques may include using predictive models to predict clinical outcomes. Some approaches may use table models in association with creating and training the models. The use of table models may be disadvantageous, as table models do not include a time axis for the data in the training set. Accordingly, for example, such model creation and training approaches may rely on a manual process of summarizing event occurrences for a member (or members) over an elapsed time period. In some cases, such approaches at most generate a summary of what has happened over a time period (e.g., in the past year), without having date stamps assigned to any individual event. In some cases, for a given member, such approaches may include manual and time intensive counting of the number of prescriptions filled, the number of ER visits, the number of provider visits, and the like over an elapsed time period to generate manually engineered features that may then be fed into predictive models.

Aspects of the present disclosure support model creation that includes the use of sequence models (e.g., instead of table models), which supports the preservation of the time dimension in training data. For example, as use of the sequence models automatically provides the time dimension, manual engineering of features may be eliminated. A sequence model is capable of learning how to summarize patient history from data, learning rules around ordering and recency, and is information preserving.

Aspects of techniques described herein for predicting clinical outcomes include the following stages. Each “stage” may also be referred to as “block.”
(1) Feature embedding stage: The feature embedding stage includes a data ingestion stage in which input data/features are prepared. For example, the feature embedding stage organizes the input data/features using a sequence model.
(2) Self-attention stage: The self-attention stage includes a “transformer” layer. In some aspects, the self-attention stage may be implemented using an off-the-shelf solution or open source solution.
(3) Outcome prediction stage. The outcome prediction stage may include multiple different clinical prediction models that are trained in parallel using the data generated at stages (1) and (2). Using the models, the outcome prediction stage may provide any type of predicted clinical outcome and temporal information corresponding to the outcome. The predicted clinical outcomes may be temporally-isolated and discrete events. Examples of the predicted clinical outcomes include: prediction if a member will visit an emergency room in the next 30 days, predicted cost associated with providing coverage to a member in the next year, predicted quantity of member visits to a primary care provider in the next 30 days, and the like.

According to example aspects of the present disclosure, a system is described herein that supports the creation of a temporal predictive model that converts features, sequentially organized by time step, to predictions for each time step. In some aspects, the system may build predictive clinical models by treating members as a sequence of days. The system may include a data pipeline and a model pipeline.

The data pipeline may collect first categorical features and organize the first categorical features by time step. For example, for a time step equal to one day, the data pipeline may organize the data such that the features are all grouped together by day. In some aspects, the data pipeline may convert numerical features into second categorical features through a process of discretization, and the data pipeline may attach the numerical features to the second categorical features. The data pipeline may include a data labelling process that goes through each feature time step (e.g., each day) for each individual. For each time step (e.g., date) associated with a feature, the data pipeline identifies if an event occurs within an outcome window (e.g., a temporal period, a quantity of time steps, etc.) from the time step.

The model pipeline may convert categorical features to a numerical representation, for example, by means of an embedding table lookup. The model pipeline may include a “within time step processing stage” including a mathematical operation (e.g., summation, averaging, etc.) and/or the application of a neural network component. The “within time step processing stage” may include converting a date into a numerical representation and mathematically combining (e.g., summation) the numerical representation of the date with the numerical representation of the categorical features. The model pipeline may include a “between time step processing stage” that processes data in a way that respects temporal ordering. In an example, the “between time step processing stage” may integrate information at a given time step with information from earlier time steps (e.g., time steps prior to the given time step) but not temporally later time steps. The integration may be implemented, for example, using a causal transformer network, a recurrent neural network, or other neural network that respects ordering.

The model pipeline may include a prediction stage that generates an output corresponding to each time step. In some aspects, the prediction stage may include comparing the output (e.g., predictions for each day) to the training labels generated in by the data labelling process of the data pipeline (e.g., events identified as occurring within some outcome window).

The model pipeline may optimize the model (e.g., using backpropagation) of the prediction stage to minimize the difference between the model output provided by the prediction stage and the output provided by the data labeling process of the data pipeline.

As will be illustrated herein, aspects of the present disclosure support a reduction in time associated with developing training sets (e.g., multiple months to manually engineer features vs. one week to automatically generate features using the techniques described herein). For example, in some other approaches, individual teams build an entire data science pipeline from scratch including all data transformations associated with machine learning operations. Such approaches are impacted by long development timelines due to use of generic data science tools, development risk (e.g., due to bugs in code and/or uneven applications of best practices), and long term, ongoing maintenance to ensure continued function. In contrast, aspects of the techniques described herein support rapidly building clinical forecasting sequencing models. The techniques described herein enable short timelines by leveraging tooling optimized for clinical forecasting, provide validated common cores conforming to specified best practices, and minimize the amount of any additional work associated with productionizing and maintaining models.

Other example advantages include increased prediction accuracy. In an example case, for a communication campaign that sought to target members at risk of a medical condition (e.g., members at high risk for musculoskeletal (MSK) surgery) in order to enroll the members in a physical therapy program, use of manually engineered training sets involved identifying about 14,000 members for the campaign, and many of the identified members turned out to be false positives. In contrast, using the trained models generated using the techniques described herein, about 2,500 members were identified for the same communication campaign, thus significantly reducing the number of false positives.

A comparison of example advantages of predictive models generated using the techniques described herein over other models is provided in the below table.

| | Models Supported by Aspects |
|---|---|
| Other Models | of the Present Disclosure |
| Define cohort | Use everyone |
| Define fixed time windows for training/ | Use all valid time windows |
| testing | per patient |
| Engineer custom feature aggregations | Use consistent Prescription, |
| | Claims, Lab, Member feature |
| | time series |
| Code all parts of model and data pipeline | Code only business/label logic |
| Inference only possible for members who | Inference possible as soon as |
| have complete feature window | a member joins |
| Multiple full-time equivalent (FTE)- | From concept to model in a |
| months to develop and support | week |
| One model per task | One multi-task model |

Example use cases which may benefit from the predictive models are described herein.

A Pharmacy Benefit Manager (PBM) working as an administrator on behalf of a pharmaceutical provider and/or insurer provider to help with pricing may utilize the predictive models in association with driving pricing mechanisms. For example, the predictive models may generate data that may provide a level of confidence to payors regarding member health and cost. In some aspects, the data may assist the PBM in forecasting events (e.g., clinical outcomes, retail outcomes, etc.) associated with a member and identifying outreach programs for preemptively addressing and/or preventing such events.

In some example implementations, a care manager may utilize the predictive models in association with care management programs (e.g., readmissions prevention) and/or next best action programs (e.g., choosing the next best action for preemptively addressing and/or preventing a clinical outcome). For example, aspects of the prediction models described herein support disease forecasting that may assist healthcare providers target interventions such as preventative care.

In some other implementations, the predictive models may assist healthcare providers and/or insurance providers in predicting undiagnosed members. Based on the predictions provided by the predictive models, the healthcare providers and/or insurance providers may more effectively recommend interventions and adjust risk assessments.

Example aspects of the present disclosure are described with reference to the following figures.

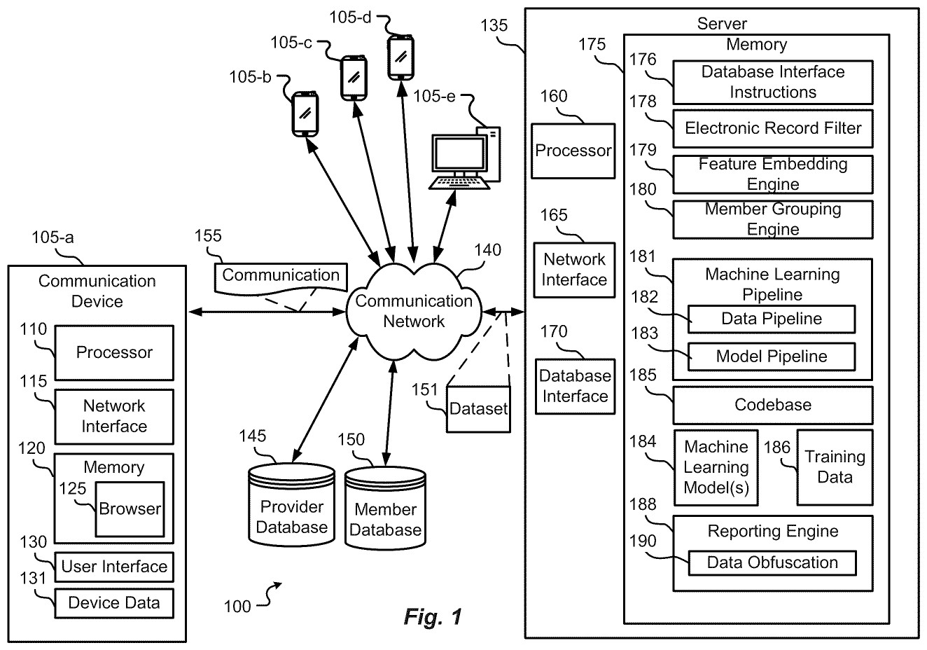

FIG. 1 illustrates an example of a system 100 in accordance with aspects of the present disclosure. The system 100, in some examples, may include one or more computing devices operating in cooperation with one another to create and apply a temporal predictive model. The system 100 may be, for example, a healthcare management system.

The components of the system 100 may be utilized to facilitate one, some, or all of the methods described herein or portions thereof without departing from the scope of the present disclosure. Furthermore, the servers described herein may include example components or instruction sets, and aspects of the present disclosure are not limited thereto. In an example, a server may be provided with all of the instruction sets and data depicted and described in the server of FIG. 1. Alternatively, or additionally, different servers or multiple servers may be provided with different instruction sets than those depicted in FIG. 1.

The system 100 may include communication devices 105 (e.g., communication device 105-a through communication device 105-e), a server 135, a communication network 140, a provider database 145, and a member database 150. The communication network 140 may facilitate machine-to-machine communications between any of the communication device 105 (or multiple communication devices 105), the server 135, or one or more databases (e.g., a provider database 145, a member database 150). The communication network 140 may include any type of known communication medium or collection of communication media and may use any type of protocols to transport messages between endpoints. The communication network 140 may include wired communications technologies, wireless communications technologies, or any combination thereof.

The Internet is an example of the communication network 140 that constitutes an Internet Protocol (IP) network consisting of multiple computers, computing networks, and other communication devices located in multiple locations, and components in the communication network 140 (e.g., computers, computing networks, communication devices) may be connected through one or more telephone systems and other means. Other examples of the communication network 140 may include, without limitation, a standard Plain Old Telephone System (POTS), an Integrated Services Digital Network (ISDN), the Public Switched Telephone Network (PSTN), a Local Area Network (LAN), a Wide Area Network (WAN), a wireless LAN (WLAN), a Session Initiation Protocol (SIP) network, a Voice over Internet Protocol (VoIP) network, a cellular network, and any other type of packet-switched or circuit-switched network known in the art. In some cases, the communication network 140 may include of any combination of networks or network types. In some aspects, the communication network 140 may include any combination of communication mediums such as coaxial cable, copper cable/wire, fiber-optic cable, or antennas for communicating data (e.g., transmitting/receiving data).

A communication device 105 (e.g., communication device 105-a) may include a processor 110, a network interface 115, a computer memory 120, a user interface 130, and device data 131. In some examples, components of the communication device 105 (e.g., processor 110, network interface 115, computer memory 120, user interface 130) may communicate over a system bus (e.g., control busses, address busses, data busses) included in the communication device 105. In some cases, the communication device 105 may be referred to as a computing resource. The communication device 105 may establish one or more connections with the communication network 140 via the network interface 115. In some cases, the communication device 105 may transmit or receive packets to one or more other devices (e.g., another communication device 105, the server 135, the provider database 145, the provider database 150) via the communication network 140.

Non-limiting examples of the communication device 105 may include, for example, personal computing devices or mobile computing devices (e.g., laptop computers, mobile phones, smart phones, smart devices, wearable devices, tablets, etc.). In some examples, the communication device 105 may be operable by or carried by a human user. In some aspects, the communication device 105 may perform one or more operations autonomously or in combination with an input by the user.

The communication device 105 may support one or more operations or procedures associated with creating and applying a temporal predictive model, as described herein. For example, the communication device 105 may support communications between multiple entities such as a healthcare provider, a medical insurance provider, a pharmaceutical manufacturer, a pharmaceutical distributor, a member, or combinations thereof. In some cases, the system 100 may include any number of communication devices 105, and each of the communication devices 105 may be associated with a respective entity.

The communication device 105 may render or output any combination of notifications, messages, reports, menus, etc. based on data communications transmitted or received by the communication device 105 over the communication network 140. For example, the communication device 105 may receive one or electronic communications 155 (e.g., from the server 135) via the communication network 140. Additionally, or alternatively, the system 100 may support communications of any electronic communications 155 between any device of the system 100, and the electronic communications 155 may include any combination of transmitted or received data as described herein.

In some aspects, the communication device 105 may render a presentation (e.g., visually, audibly, using haptic feedback, etc.) of the electronic communication 155 via the user interface 130. The user interface 130 may include, for example, a display, an audio output device (e.g., a speaker, a headphone connector), or any combination thereof. In some aspects, the communication device 105 may render a presentation using one or more applications (e.g., a browser application 125) stored on the memory 120. In an example, the browser application 125 may be configured to receive the electronic communication 155 in an electronic format (e.g., in an electronic communication via the communication network 140) and present content of the electronic communication 155 via the user interface 130.

In some aspects, the server 135 may communicate the electronic communication 155 to a communication device 105 (e.g., communication device 105-a) of a member, a communication device 105 (e.g., communication device 105-b) of a healthcare provider, a communication device 105 (e.g., communication device 105-c) of an insurance provider, a communication device 105 (e.g., communication device 105-d) of a pharmacist or pharmacy, a communication device 105 (e.g., communication device 105-e) of team outreach personnel, or the like. Additionally, or alternatively, the server 135 may communicate a physical representation (e.g., a letter) of the electronic communication 155 to the member, a healthcare provider, an insurance provider, a pharmacist, team outreach personnel, or the like via a direct mail provider (e.g., postal service).

In some aspects, the electronic communication 155 may include an indication of a predictive model generated by the system 100 (e.g., by a machine learning pipeline 181), outputs provided by the predictive model, and performance results associated with the predictive model. Example aspects of the predictive model, outputs provided by the predictive model, and performance results associated with the predictive model are later described herein.

The provider database 145 and the member database 150 may include member electronic records (also referred to herein as a data records) stored therein. In some aspects, the electronic records may be accessible to a communication device 105 (e.g., operated by healthcare provider personnel, insurance provider personnel, a member, a pharmacist, etc.) and/or the server 135. In some aspects, a communication device 105 and/or the server 135 may receive and/or access the electronic records from the provider database 145 and the member database 150 (e.g., based on a set of permissions). In an example, the communication device 105 and/or server 135 may access a dataset 151 (e.g., associated with a member or members) from the provider database 145 and/or the member database 150.

In some other aspects, the electronic records may include device data 131 obtained from a communication device 105 (e.g., communication device 105-a) associated with the member. For example, the device data 131 may include gyroscopic data, accelerometer data, beacon data, glucose readings, heart rate data, blood pressure data, blood oxygen data, temperature data, kinetics data, location data, motion data, a device identifier, and/or temporal data (e.g., a timestamp) measurable, trackable, and/or providable by the communication device 105 (or a device connected to the communication device 105) associated with the member. In some aspects, the device data 131 may include information associated with a structured diet plan and/or exercise plan. For example, the device data 131 may include data logged in association with a diet logging application and/or exercise logging application executed at the communication device 105.

In some aspects, the electronic records may include an image of the member. For example, the electronic record may include imaging data based on which the server 135 may track members. For example, the server 135 may track X-ray records of a member over time (e.g., in association with assisting reduced healing times for a member). In some cases, the electronic record may include other types of diagnostic images such as magnetic resonance imaging (MRI) scans, computed tomography scans (CT), ultrasound images, or the like.

In some aspects, the dataset 151 may include electronic medical record (EMR) data. The dataset 151 may include data describing an insurance medical claim, pharmacy claim, and/or insurance claim made by the member and/or a medical provider. Accordingly, for example, the dataset 151 may come from providers or payers, and claims included in the claims-based electronic data may be of various types (e.g., medical, pharmacy, etc.).

In accordance with aspects of the present disclosure, the device data 131 may be provided continuously, semi-continuously, periodically, and/or based on a trigger condition by the communication device 105 (e.g., a smart watch, a wearable monitor, a self-reporting monitor such as a glucometer, a smartphone carried by a user, etc.) around monitored parameters such as heartbeat, blood pressure, etc. In some aspects, the device data 131 of a communication device 105 (e.g., communication device 105-a) may be referred to as “environmental data” associated with a user, which may be representative of aspects of environmental factors (e.g., lifestyle, socioeconomic factors, details about the environment, etc.) associated with a member. Aspects of the present disclosure support processing data accessed from the provider database 145, the member database 150, and/or the device data 131, exclusively or in combination.

In some aspects, the electronic records may include genetic data associated with a member. In some other aspects, the electronic record may include notes/documentation that is recorded at a communication device 105 in a universal and/or systematic format (e.g., subjective, objective, assessment, and plan (SOAP) notes/documentation) among medical providers, insurers, etc. In some examples, the electronic records may include non-claim adjudicated diagnoses input at a communication device 105 (e.g., diagnoses that have not been evaluated by an insurance provider with respect to payment of benefits).

In some other aspects, the electronic records may be inclusive of aspects of a member's health history and health outlook. The electronic records may include a number of fields for storing different types of information to describe the member's health history and health outlook. As an example, the electronic records may include personal health information (PHI) data. The PHI data may be stored encrypted and may include member identifier information such as, for example, name, address, member number, social security number, date of birth, etc. In some aspects, the electronic records may include treatment data such as, for example, member health history, member treatment history, lab test results (e.g., text-based, image-based, or both), pharmaceutical treatments and therapeutic treatments (e.g., indicated using predefined healthcare codes, treatment codes, or both), insurance claims history, healthcare provider information (e.g., doctors, therapists, etc. involved in providing healthcare services to the member), in-member information (e.g., whether treatment is associated with care), location information (e.g., associated with treatments or prescriptions provided to the member), family history (e.g., inclusive of medical data records associated with family members of the member, data links to the records, etc.), or any combination thereof. In some aspects, the electronic records may be stored or accessed according to one or more common field values (e.g., common parameters such as common healthcare provider, common location, common claims history, etc.). In some aspects, the system 100 may support member identifiers based on which a server 135 and/or a communication device 105 may access and/or identify key health data per member different from the PHI data.

A “gap-in-care” or “care gap” described herein may be defined by a difference between guideline behavior associated with what a member should be doing, as defined by clinical guidelines and expert clinical opinion (e.g., professional guidelines surrounding preventative screenings and close follow-up and monitoring with healthcare providers) and current health related behavior associated with what the member is actually doing, which may be defined by static or longitudinal observables in the medical history of the member and supporting data. Aspects of the present disclosure support measured observables (e.g., measured biometric data) and predicted observables (e.g., biometric data predicted using machine learning techniques based on other data such as claims-based data, prescription-based data, device data 131, user entered data, or the like).

In some aspects, the provider database 145 may be accessible to a healthcare provider of a member, and in some cases, include member information associated with the healthcare provider that provided a treatment to the member. In some aspects, the provider database 145 may be accessible to an insurance provider associated with the member. The member database 150 may correspond to any type of known database, and the fields of the electronic records may be formatted according to the type of database used to implement the member database 150. Non-limiting examples of the types of database architectures that may be used for the member database 150 include a relational database, a centralized database, a distributed database, an operational database, a hierarchical database, a network database, an object-oriented database, a graph database, a NoSQL (non-relational) database, etc. In some cases, the member database 150 may include an entire healthcare history or journey of a member, whereas the provider database 145 may provide a snapshot of a member's healthcare history with respect to a healthcare provider. In some examples, the electronic records stored in the member database 150 may correspond to a collection or aggregation of electronic records from any combination of provider databases 145 and entities involved in the member's healthcare delivery (e.g., a pharmaceutical distributor, a pharmaceutical manufacturer, etc.).

The provider database 145 and/or the member database 150 may include medical condition indicators recorded for each member using a database format associated with the provider database 145 and/or the member database 150. In some aspects, the provider database 145 and/or the member database 150 may support diagnosis and procedure codes classified according to the International Classification of Diseases 10th revision (ICD-10) and Current Procedure Terminology 4th revision (CPT-4) codes. In some aspects, the provider database 145 and/or the member database 150 may support the use of Generic Product Identifier (GPI) and National Drug Code (NDC) Directory information for common diabetes medications. The provider database 145 and/or member database 150 may include demographic information, including age, gender, race, and geography, identified using claims data. The provider database 145 and/or member database 150 may include data such as proportion of days covered (PDC), calculated as a ratio of the number of days in a period covered to the number of days in a given period for each member and corresponding medication.

In an example implementation, the dataset 151 described herein as accessed from the provider database 145 and/or member database 150 may include claims-based electronic data and/or prescription-based electronic data (also referred to herein as claims-based data and prescription-based data, respectively). For example, the dataset 151 may include claims-based electronic data including Current Procedural Terminology (CPT) codes and National Drug Code (NDC) numbers.

The server 135 may include a processor 160, a network interface 165, a database interface 170, and a memory 175. In some examples, components of the server 135 (e.g., processor 160, a network interface 165, a database interface 170, and a memory 175) may communicate via a system bus (e.g., any combination of control busses, address busses, and data busses) included in the server 135. Aspects of the processor 160, network interface 165, database interface 170, and memory 175 may support example functions of the server 135 as described herein. For example, the server 135 may transmit packets to (or receive packets from) one or more other devices (e.g., one or more communication devices 105, another server 135, the provider database 145, the provider database 150) via the communication network 140. In some aspects, via the network interface 165, the server 135 may transmit database queries to one or more databases (e.g., provider database 145, member database 150) of the system 100, receive responses associated with the database queries, or access data associated with the database queries.

In some aspects, via the network interface 165, the server 135 may transmit one or more electronic communications 155 described herein to one or more communication devices 105 of the system 100. The network interface 165 may include, for example, any combination of network interface cards (NICs), network ports, associated drivers, or the like. Communications between components (e.g., processor 160, network interface 165, database interface 170, and memory 175) of the server 135 and other devices (e.g., one or more communication devices 105, the provider database 145, the provider database 150, another server 135) connected to the communication network 140 may, for example, flow through the network interface 165.

The processors described herein (e.g., processor 110 of the communication device 105, processor 160 of the server 135) may correspond to one or many computer processing devices. For example, the processors may include a silicon chip, such as a Field Programmable Gate Array (FPGA), an Application-Specific Integrated Circuit (ASIC), any other type of Integrated Circuit (IC) chip, a collection of IC chips, or the like. In some aspects, the processors may include a microprocessor, a Central Processing Unit (CPU), a Graphics Processing Unit (GPU), or plurality of microprocessors configured to execute the instructions sets stored in a corresponding memory (e.g., memory 120 of the communication device 105, memory 175 of the server 135). For example, upon executing the instruction sets stored in memory 120, the processor 110 may enable or perform one or more functions of the communication device 105. In another example, upon executing the instruction sets stored in memory 175, the processor 160 may enable or perform one or more functions of the server 135.

The processors described herein (e.g., processor 110 of the communication device 105, processor 160 of the server 135) may utilize data stored in a corresponding memory (e.g., memory 120 of the communication device 105, memory 175 of the server 135) as a neural network. The neural network may include a machine learning architecture. In some aspects, the neural network may be or include one or more classifiers. In some other aspects, the neural network may be or include any machine learning network such as, for example, a deep learning network, a convolutional neural network, or the like. Some elements stored in memory 120 may be described as or referred to as instructions or instruction sets, and some functions of the communication device 105 may be implemented using machine learning techniques. In another example, some elements stored in memory 175 may be described as or referred to as instructions or instruction sets, and some functions of the server 135 may be implemented using machine learning techniques.

In some aspects, the processors (e.g., processor 110, processor 160) may support machine learning model(s) 184 which may be trained and/or updated based on data (e.g., training data 186) provided or accessed by any of the communication device 105, the server 135, the provider database 145, and the member database. The machine learning model(s) 184 may be built and updated by any of the engines described herein based on the training data 186 (also referred to herein as training data and feedback). For example, the machine learning model(s) 184 may be trained with feature vectors of members (e.g., accessed from provider database 145 or member database 150) in association with clinical outcomes, retail outcomes (e.g., cost), and corresponding temporal data.

In some aspects, the processors (e.g., processor 110, processor 160) may support implementing a machine learning pipeline 181 capable of developing a model 184 capable of predicting a desired target (e.g., a predicted clinical outcome and/or retail outcome). Example aspects of developing and implementing the model 184 are described later herein.

In some aspects, training the machine learning model(s) 184 may be based on a target prediction accuracy of the machine learning model(s) 184. For example, training may include building and validating the machine learning model(s) 184 for creating a temporal predictive model and applying the model for predicting outcomes associated with individuals.

The machine learning model(s) 184 may be provided in any number of formats or forms. Example aspects of the machine learning model(s) 184, such as generating (e.g., building, training) and applying the machine learning model(s) 184, are described with reference to the figure descriptions herein.

Non-limiting examples of the machine learning model(s) 184 include Decision Trees, gradient-boosted decision tree approaches (GBMs), Support Vector Machines (SVMs), Nearest Neighbor, and/or Bayesian classifiers, and neural-network-based approaches. In some aspects, the machine learning model(s) 184 may be implemented in association with a causal transformer network, a recurrent neural network, or other neural network that respects ordering.

In some aspects, the machine learning model(s) 184 may include ensemble classification models (also referred to herein as ensemble methods) such as gradient boosting machines (GBMs). Gradient boosting techniques may include, for example, the generation of decision trees one at a time within a model, where each new tree may support the correction of errors generated by a previously trained decision tree (e.g., forward learning). Gradient boosting techniques may support, for example, the construction of ranking models for information retrieval systems. A GBM may include decision tree-based ensemble algorithms that support building and optimizing models in a stage-wise manner.

According to example aspects of the present disclosure described herein, the machine learning model(s) 184 may include Gradient Boosting Decision Trees (GBDTs). Gradient boosting is a supervised learning technique that harnesses additive training and tree boosting to correct errors made by previous models, or regression trees.

The machine learning model(s) 184 may include extreme gradient boosting (CatBoost) models. CatBoost is an ensemble learning method based on GBDTs. In some cases, CatBoost methods may have improved performance compared to comparable random forest-based methods. CatBoost methods are easily tunable and scalable, offer a higher computational speed in comparison to other methods, and are designed to be highly integrable with other approaches including Shapley Additive Explanations (SHAP) values.

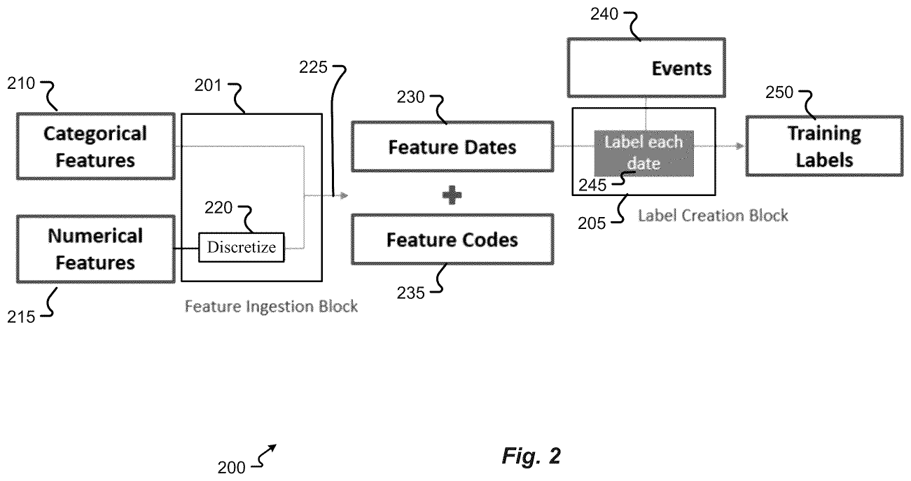

Examples implementations of training and prediction using neural networks and machine learning model(s) 184 of the system 100 are described herein with reference to FIGS. 2, 3, and 4A through 4C.

In some aspects, the machine learning model(s) 184 may include ensemble classification models (also referred to herein as ensemble methods) such as random forests. Random forest techniques may include independent training of each decision tree within a model, using a random sample of data. Random forest techniques may support, for example, medical diagnosis techniques described herein using weighting techniques with respect to different data sources.

Various example aspects of the machine learning model(s) 184, inputs to the machine learning model(s) 184, and the training data 186 with respect to the present disclosure are described here.

The memory described herein (e.g., memory 120, memory 175) may include any type of computer memory device or collection of computer memory devices. For example, a memory (e.g., memory 120, memory 175) may include a Random Access Memory (RAM), a Read Only a Memory (ROM), a flash memory, an Electronically-Erasable Programmable ROM (EEPROM), Dynamic RAM (DRAM), or any combination thereof.

The memory described herein (e.g., memory 120, memory 175) may be configured to store instruction sets, neural networks, and other data structures (e.g., depicted herein) in addition to temporarily storing data for a respective processor (e.g., processor 110, processor 160) to execute various types of routines or functions. For example, the memory 175 may be configured to store program instructions (instruction sets) that are executable by the processor 160 and provide functionality of any of the engines described herein.

The memory described herein (e.g., memory 120, memory 175) may also be configured to store data or information that is useable or capable of being called by the instructions stored in memory. Examples of data that may be stored in memory 175 for use by components thereof include machine learning model(s) 184 and/or training data 186 described herein.

Any of the engines described herein may include a single or multiple engines.

With reference to the server 135, the memory 175 may be configured to store instruction sets, neural networks, and other data structures (e.g., depicted herein) in addition to temporarily storing data for the processor 160 to execute various types of routines or functions. The illustrative data or instruction sets that may be stored in memory 175 may include, for example, database interface instructions 176, an electronic record filter 178 (also referred to herein as a feature vector filter), a feature embedding engine 179, a machine learning pipeline 181, and a reporting engine 188. In some examples, the reporting engine 188 may include data obfuscation capabilities 190 via which the reporting engine 188 may obfuscate, remove, redact, or otherwise hide personally identifiable information (PII) from an electronic communication 155 prior to transmitting the electronic communication 155 to another device (e.g., communication device 105).

In some examples, the database interface instructions 176, when executed by the processor 160, may enable the server 135 to send data to and receive data from the provider database 145, the member database 150, or both. For example, the database interface instructions 176, when executed by the processor 160, may enable the server 135 to generate database queries, provide one or more interfaces for system administrators to define database queries, transmit database queries to one or more databases (e.g., provider database 145, the member database 150), receive responses to database queries, access data associated with the database queries, and format responses received from the databases for processing by other components of the server 135.

The server 135 may use the electronic record filter 178 in connection with processing data received from the various databases (e.g., provider database 145, member database 150). For example, the electronic record filter 178 may be leveraged by the database interface instructions 176 to filter or reduce the number of electronic records (e.g., feature vectors) provided to any of the feature embedding engine 179, the member grouping engine 180, and the machine learning pipeline 181. In an example, the database interface instructions 176 may receive a response to a database query that includes a set of feature vectors (e.g., a plurality of feature vectors associated with different members). In some aspects, any of the database interface instructions 176, the feature embedding engine 179, the member grouping engine 180, and the machine learning pipeline 181 may be configured to utilize the electronic record filter 178 to reduce (or filter) the number of feature vectors received in response to the database query, for example, prior to processing data included in the feature vectors.

The feature embedding engine 179 may receive, as input, sequences of medical terms extracted from claim data (e.g., medical claims, pharmacy claims) for each member. In an example, the feature embedding engine 179 may process the input using neural word embedding algorithms such as Word2vec. In some examples, the feature embedding engine 179 may process the input using Transformer algorithms (e.g., algorithms associated with language models such as Bidirectional Encoder Representations from Transformers (BERT) or Generative Pre-trained Transformer (GPT) or graph convolutional transformer (GCT)) and respective attentional mechanisms. In some aspects, based on the processing, the feature embedding engine 179 may compute and output respective dimension weights for the medical terms. In some aspects, the dimension weights may include indications of the magnitude and direction of the association between a medical code and a dimension. In an example, the feature embedding engine 179 may compute an algebraic average of all the medical terms for each member over any combination of dimensions (e.g., over all dimensions). In some aspects, the algebraic average may be provided by the feature embedding engine 179 as additional feature vectors in a predictive model described herein (e.g., classifier).

The member grouping engine 180, when executed by the processor 160, may enable the server 135 to group data records of various members according to a common value(s) in one or more fields of such data records. For example, the member grouping engine 180 may group electronic records based on commonalities in parameters such as health conditions (e.g., diagnosis of diabetes, open gaps-in-care, closed gaps-in-care, suggested actions associated with closing a gap-in-care, impact associated with at least partially closing the gap-in-care, etc.), medical treatment histories, prescriptions, healthcare providers, locations (e.g., state, city, ZIP code, etc.), gender, age range, medical claims, pharmacy claims, lab results, medication adherence, demographic data, social determinants (also referred to herein as social indices), biomarkers, behavior data, engagement data, historical gap-in-care data, machine learning model-derived outputs, combinations thereof, and the like.

In some aspects, the server 135 (e.g., using the machine learning pipeline 181) may generate a temporal predictive model capable of predicting outcomes (e.g., clinical outcomes, retail outcomes) of a member with respect to a temporal aspect. In some aspects, the predicted outcomes may be based on medical history, demographics, social indices, biomarkers, behavior data, engagement data, gap-in-care data, machine learning model-derived output(s), and/or other factors that correspond to the member and/or other members.

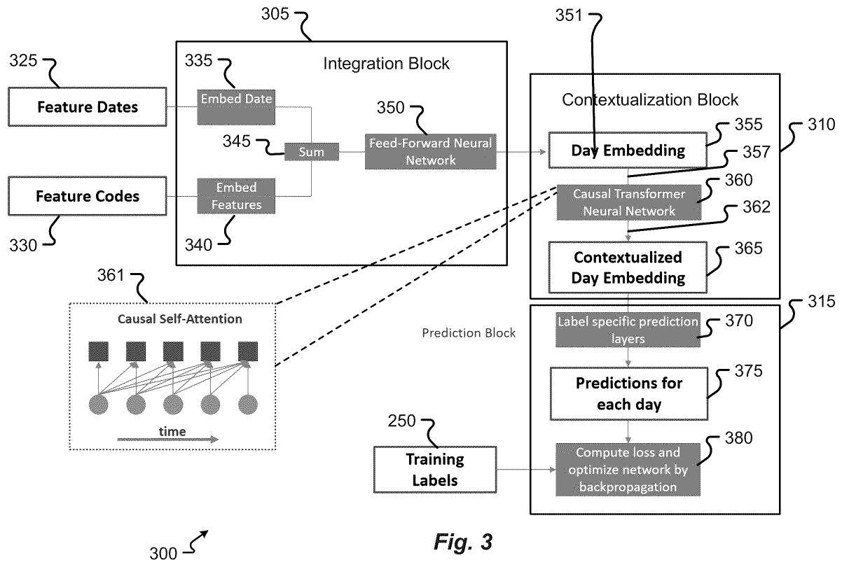

The machine learning pipeline 181 may include a data pipeline 182 and a model pipeline 183. Example aspects of the data pipeline 182 and the model pipeline 183 are later described with reference to FIGS. 2 and 3.

The machine learning pipeline 181 may support calling of any suitable function of the machine learning pipeline 181. That is, for example, blocks of the machine learning pipeline 181 (e.g., of the data pipeline 182 and/or the model pipeline 183) and the operations supported by the blocks may correspond to callable functions. The server 135 may provide access to the callable functions via a codebase 185.

In an example, the server 135 may provide users access to features of the codebase based on authorization levels associated with the users. For example, for an internal user of the system 100 (e.g., a data scientist associated with the system 100), the server 135 may provide the codebase 185 as a series of data files in which the internal code is visible to the internal user. The system 100 may support calling of any suitable function (e.g., blocks described herein) of the machine learning pipeline 181 by the internal user. Additionally, or alternatively, the system 100 may support edits to the code by the internal user. Example edits to the code as supported by the system 100 include removal, additions, and edits to blocks (and thereby, functionalities) of the machine learning pipeline 181. The features of editing the code support adapting the machine learning pipeline 181 to specific use-cases desired by the internal user. In some examples, edits to the code may increase accuracy, processing efficiency, and/or processing speed of a machine learning model(s) of the machine learning pipeline 181.

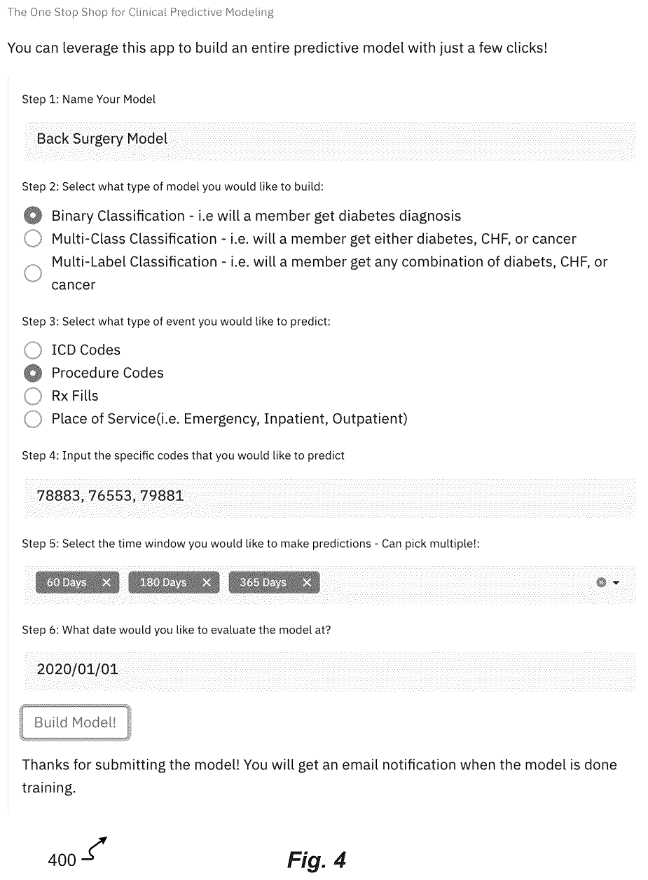

For a user external to the system 100 (also referred to herein as an external user or a third-party user), the server 135 may provide the codebase 185 through a license associated with accessing features of the codebase 185, without providing access to or visibility of the internal code (e.g., through file permissions, data encryption, etc.). In an example, the system 100 may support calling of any suitable function (e.g., blocks described herein) of the machine learning pipeline 181 by the external user. The server 135 may prevent edits to the code by the external user, for example, as the code is not accessible or visible by the external user. In an example implementation, the system 100 may provide a user interface for an external user (e.g., a customer, a non-technical user, etc.) to input data and/or input a file with data. The server 135 may process the file through the machine learning pipeline 181 and provide output data (e.g., a predictive model, a predicted outcome and temporal information generated by the predictive model, etc.), without exposing the codebase 185. An example of the user interface is later described with reference to FIG. 4.

The reporting engine 188, when executed by the processor 160, may enable the server 135 to output one or more electronic communications 155 based on data generated by any of the feature embedding engine 179, the member grouping engine 180, and the machine learning pipeline 181. The reporting engine 188 may be configured to generate electronic communications 155 in various electronic formats, printed formats, or combinations thereof. Some example formats of the electronic communications 155 may include HyperText Markup Language (HTML), electronic messages (e.g., email), documents for attachment to an electronic message, text messages (e.g., SMS, instant messaging, etc.), combinations thereof, or any other known electronic file format. Some other examples include sending, for example, via direct mail, a physical representation (e.g., a letter) of the electronic communication 155.

The reporting engine 188 may also be configured to hide, obfuscate, redact, or remove PII data from an electronic communication 155 prior to transmitting the electronic communication 155 to another device (e.g., a communication device 105, the server 135, etc.). In some aspects, a communication device 105 may also be configured to hide, obfuscate, redact, or remove PII data from direct mail (e.g., a letter) prior to generating a physical representation (e.g., a printout) of an electronic communication 155. In some examples, the data obfuscation may include aggregating electronic records to form aggregated member data that does not include any PII for a particular member or group of members. In some aspects, the aggregated member data generated by the data obfuscation may include summaries of data records for member groups, statistics for member groups, or the like.

Example illustrative aspects of the system 100 are described with reference to FIGS. 1 through 7.

FIG. 2 illustrates an example of a data pipeline 200 in accordance with aspects of the present disclosure. The data pipeline 200 may include aspects of like elements described herein described with reference to FIG. 1. Aspects of the data pipeline 200 may be implemented by a server 135 and/or a device 105 described with reference to FIG. 1. In some aspects, the data pipeline 200 may be referred to as a model-building system.

The data pipeline 200 may include a feature ingestion block 201 and a label creation block 205. The feature ingestion block 201 may be capable of combining received datasets. For example, the feature ingestion block 201 may receive a dataset 210 and a dataset 215. In an example, the dataset 210 includes categorical features from clinical data and the dataset 215 includes numerical features from clinical data.

In some aspects, the feature ingestion block 201 may collect and organize the categorical features of the first dataset 210 by time step. For example, for a time step equal to one day, the data pipeline 200 may organize the data included in the first dataset 210 such that the categorical features are grouped together by day.

At 220, the feature ingestion block 201 may discretize the dataset 215. Discretization at 220 may include transforming the numerical features (e.g., data) of the dataset 215 into a discrete form. For example, at 220, the feature ingestion block 201 creates a set of contiguous intervals (or bins) associated with the numerical features such that the result (e.g., discrete data) is countable. In some aspects, at 220, the feature ingestion block 201 may convert the numerical features into another set of categorical features through discretization. In some aspects, the feature ingestion block 201 attaches the numerical features to the categorical features.

The feature ingestion block 201 may sum the dataset 210 and the dataset 215. For example, the feature ingestion block 201 may sum the dataset 210 (e.g., first categorical features) and the discretized form of the dataset 215 (e.g., second categorical features having numerical features attached thereto).

The feature ingestion block 201 may provide an output 225 that corresponds to a result of summing the datasets. In an example, the output 225 may include feature dates 230 and feature codes 235. The terms “feature dates” and “date features” may be used interchangeably herein.

The label creation block 205 may receive the output 225 from the feature ingestion block 201. At 245, the label creation block 205 may generate training labels 250 based on the feature dates 230 and feature codes 235. The training labels 250 may include contextual information based on which a machine learning model can learn.

For example, the label creation block 205 may implement a data labelling process that goes through each feature time step (e.g., each day) for each individual associated with the dataset 210 and the dataset 215. For each time step (e.g., day, date, etc.) associated with a feature, the label creation block 205 identifies if an event 240 occurs within an outcome window (e.g., a temporal period, a quantity of time steps, etc.) from the time step. The event 240 may be, for example, a clinical event (clinical outcome), a retail event (retail outcome), or a temporal event (temporal outcome).

Accordingly, for example, using the training labels 250, the system 100 described herein may predict temporally-isolated and discrete events. For example, the system 100 may predict what may happen for a population of people at different time frames. The system 100 may score (or rank) the different predictions and use the scores (or rankings) to decide what might occur. In some aspects, the system 100 may provide the scores (or rankings) to a user for review. In some aspects, using the training labels 250, the system 100 may train and optimize one or more machine learning networks for predicting temporally-isolated and discrete events, example aspects of which are described herein.

FIG. 3 illustrates an example of a model pipeline 300 in accordance with aspects of the present disclosure. The model pipeline 300 may include aspects of like elements described with reference to FIG. 1. Aspects of the model pipeline 300 may be implemented by a server 135 and/or a device 105 described with reference to FIG. 1. In some aspects, the model pipeline 300 may be referred to as a prediction system.

According to example aspects of the present disclosure, the model pipeline 300 may support predicting clinical outcomes. The model pipeline 300 may include an integration block 305 (also referred to herein as a “feature embedding stage”), a contextualization block 310 (also referred to herein as a “self-attention stage”), and a prediction block 315 (also referred to herein as an “outcome prediction stage” or a “prediction stage”).

The integration block 305 may create a numerical representation of a day based on feature dates 325 and feature codes 330. The integration block 305 may convert categorical features (e.g., feature dates 325, feature codes 330) to numerical representations, for example, by use of an embedding table lookup.

For example, at 335, the integration block 305 may embed dates with feature dates 325. In some aspects, the embedding of dates at 335 may be referred to as non-learned date embedding. At 340, the integration block 305 may embed features with the feature codes 330. In some aspects, the embedding of features at 340 may be referred to as learned feature embedding. The integration block 305 may provide a summation (implemented at 345) of the non-learned date embedding with the learned feature embedding to a neural network 350, and the neural network 350 may provide the summation to the contextualization block 310. In an example, the neural network 350 may be a feed-forward neural network.

The contextualization block 310 may be referred to as a “between time step processing stage” that integrates information at a given time step with information from earlier time steps (e.g., time steps prior to the given time step) but not temporally later time steps. For example, the contextualization block 310 may embed dates with the output 351 of the neural network 350 through date embedding 355 (also referred to herein as “day embedding”).

Using a neural network 360 (e.g., a causal transformer network, a recurrent neural network, or other neural network that respects ordering), the contextualization block 310 may process the date embedded data 357 in a way that respects and/or maintains a temporal ordering. The neural network 360 may be referred to as a “self-attention stage” or “transformer” layer. In some aspects, the neural network 360 may be implemented using causal self-attenuation mechanism 361 capable of relating different positions of a single sequence in order to compute a representation of the same sequence. In an example, the causal self-attention mechanism 361 may be an 8× causal self-attention mechanism.

The contextualization block 310 may provide features for contextualized date embedding 365 (also referred to herein as “contextualized day embedding”). For example, at contextualized date embedding 365, the contextualization block 310 may embed contextual information (e.g., clinical history, historical patient data, etc.) into the output 362 generated by the neural network 360. At contextualized date embedding 365, the contextualization block 310 may contextualize a numerical representation of a day based on a clinical history of an individual.

The prediction block 315 may provide predicted outcomes 375. For example, the prediction block 315 may generate predicted outcomes 375 using prediction layers 370. In an example, the prediction layers 370 may include label-specific prediction layers.

The predicted outcomes 375 may include predictions for each time step (e.g., each temporal period, each day, each week, each month, etc.). For example, the predicted outcomes 375 may include predictions for each day. In some aspects, the predicted outcomes 375 may include predictions of whether an event will occur within an outcome window (e.g., a temporal period, a quantity of days, etc.) from a given day. The terms “outcome window” and “forecast window” may be used interchangeably herein.

The predicted outcomes 375 include multiple predicted outcomes and multiple different times. Each predicted outcome may have a different probability of likelihood and a different ranking. Based on the different times and respective ranks, the system 100 (with or without user input) may choose which predicted outcomes to target for intervention.

At 380, the prediction block 315 may compare the predicted outcomes 375 to the training labels 250 generated by the labeling process of the data pipeline 200. For example, the prediction block 315 may compare the predicted outcomes 375 to the events identified by the data pipeline 200 (and indicated by the training labels 250) as occurring within some outcome window.

In some aspects, at 380, the prediction block 315 may optimize (e.g., using backpropagation) the model(s) used for generating the predicted outcomes 375. In some aspects, the prediction block 315 may modify or optimize the models to minimize the difference between the output (e.g., the predicted outcomes 375) of the prediction block 315 and the output (e.g., events identified by the training labels 250) of the data pipeline 200. In some cases, the prediction block 315 may modify or optimize the models until the difference is less than a threshold value.

In some aspects, the system 100 may provide data via which an operator (e.g., healthcare personnel, a data scientist, etc.) may evaluate the performance of the model(s) used for generating the predicted outcomes 375. For example, the system 100 may generate and provide an N×N confusion matrix for evaluating the performance of a classification model, where N is the number of target classes. The confusion matrix provides a comparison of actual target values with those predicted by the model pipeline 300. In some aspects, the system 100 may generate and provide graphs such as receiver operating characteristic (ROC) curves that show the performance of a classification model at all classification thresholds. An ROC curve plots “True Positive Rate” and “False Positive Rate” with respect to different classification thresholds (also referred to herein decision thresholds).

The system 100 may optimize (e.g., using backpropagation) the model(s) based on feedback provided by the operator. In some other aspects, the system 100 may autonomously optimize (e.g., using backpropagation) the models used for generating the predicted outcomes 375 based on values indicated by the confusion matrix and/or ROC curves.

FIG. 4 illustrates an example implementation of a user interface 400 supported by aspects of the present disclosure. In some aspects, the system 100 may provide the user interface 400 via a communication device 105 (e.g., a personal computing device, a smartphone, etc.) described herein.

In an example, the system 100 may provide the user interface 400 to a user (e.g., a customer, a non-technical user, a third party, etc.) external to the system 100, via which the user may request the system 100 to generate a predictive model. Via the user interface 400, the system 100 may provide such users access to the predictive models supported by the system 100 while protecting underlying intellectual property (e.g., codebase 185) and/or other data (e.g., patient data and/or medical data based on which the system 100 generates predictive models). The user may be an entity that does not provide or have access to any of the patient data and medical data used in association with generating the predictive models.

In an example, the system 100 may further receive data sets from a third party user and, using the predictive models, generate predictions about individuals (e.g., members, patients, customers, etc.) associated with the third party. In some aspects, the data sets from the third party may include patient data (e.g., identification information, historical medical records, claims-based data, pharmacy data, etc.) for the individuals associated with the third party.

In some aspects, the system 100 may provide data to the user for evaluating the performance of a generated predictive model. For example, the system 100 may provide data including prediction results generated by the predictive model. In some aspects, the system 100 may provide data including a confusion matrices and/or ROC curves described herein to the user.

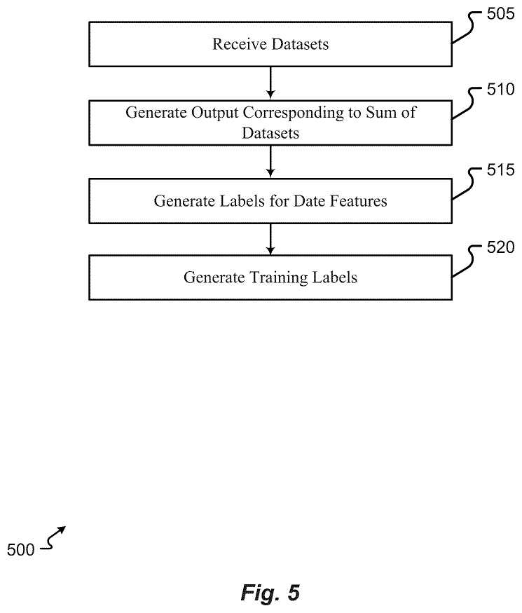

FIG. 5 illustrates an example of a process flow 500 that supports creating a temporal predictive model in accordance with aspects of the present disclosure. In some examples, process flow 500 may be implemented by a data pipeline described with reference to FIGS. 1 and 2.

In the following description of the process flow 500, the operations may be performed in a different order than the order shown, or the operations may be performed in different orders or at different times. Certain operations may also be left out of the process flow 500, or other operations may be added to the process flow 500.

At 505, an input receives a first dataset representing categorical features and a second dataset representing numerical features.

At 510, a feature ingestion block generates an output corresponding to a sum of the first dataset with the second dataset.

At 515, a label creation block receives the output from the feature ingestion block and generates labels for date features in the first dataset.

At 520, an output provides training labels based on a processing of the summed first dataset and second dataset to predict a temporally-isolated and discrete event.

In some aspects, the second dataset is discretized prior to being summed with the first dataset; and discretizing the second dataset includes converting numerical features of the second dataset into categorical features.

In some aspects: the first dataset includes categorical features from clinical data; and the second dataset includes numerical features from the clinical data.

In some aspects, a model is used to predict the training labels.

In some aspects: the model includes a temporal axis and is configured to process discrete time steps; and the training labels correspond to specific time steps in the discrete time steps, time windows associated with one or more of the specific time steps, or both.

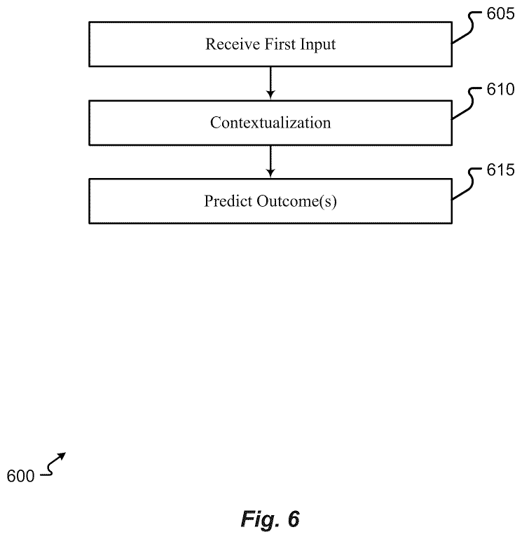

FIG. 6 illustrates an example of a process flow 600 that supports creating a temporal predictive model in accordance with aspects of the present disclosure. In some examples, process flow 600 may be implemented by a machine learning pipeline described with reference to FIGS. 1 and 2.

In the following description of the process flow 600, the operations may be performed in a different order than the order shown, or the operations may be performed in different orders or at different times. Certain operations may also be left out of the process flow 600, or other operations may be added to the process flow 600.

At 605, one or more neural networks of the machine learning pipeline receive a first input corresponding to a summation of non learned date embedding with learned feature embedding.

At 610, the one or more neural networks contextualize the summation of the non learned date embedding with the learned feature embedding by date embedding historical patient data into the summation of the non learned date embedding with the learned feature embedding.

At 615, a prediction block of the machine learning pipeline receives the contextualized summation of the non-learned date embedding with the learned feature embedding and predicts one or more outcomes.

In some aspects, the one or more neural networks include at least a feed forward neural network that receives the first input.

In some aspects, the one or more neural networks include at least a causal transformer neural network that contextualizes the summation of the non learned date embedding with the learned feature embedding.

In some aspects, the one or more neural networks maintain a temporal ordering of data associated with the contextualized summation of the non-learned date embedding with the learned feature embedding.

In some aspects: the non learned date embedding includes feature dates with embedded dates; and the learned feature embedding includes feature codes with embedded features.

In some aspects: the one or more outcomes include a plurality of outcomes; and each of the plurality of outcomes has a different probability of likelihood.

In some aspects, the one or more outcomes include a clinical outcome.

In some aspects, the one or more outcomes include a retail outcome.

In some aspects, the one or more outcomes include a temporal event.

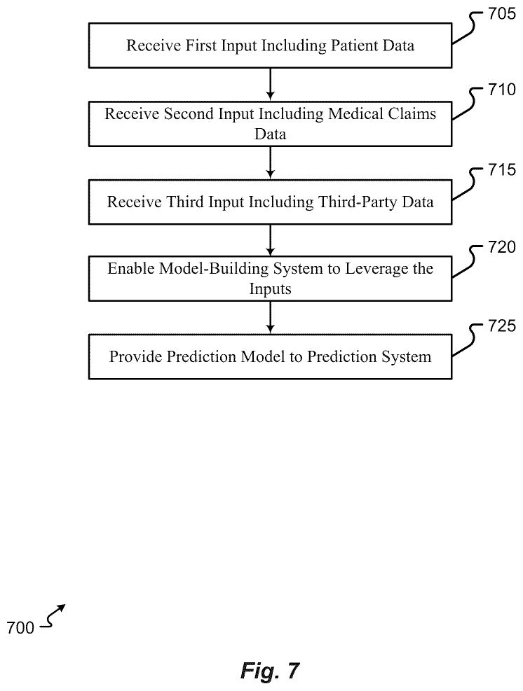

FIG. 7 illustrates an example of a process flow 700 that supports creating a temporal predictive model in accordance with aspects of the present disclosure. In some examples, process flow 700 may be implemented by a system 100 (e.g., a machine learning pipeline 181, a data pipeline 182, a model pipeline 183, etc.) described with reference to FIGS. 1 through 3.

In the following description of the process flow 700, the operations may be performed in a different order than the order shown, or the operations may be performed in different orders or at different times. Certain operations may also be left out of the process flow 700, or other operations may be added to the process flow 700.

It is to be understood that while a device 105 or server 135 is described as performing a number of the operations of process flow 700, any device (e.g., another device 105, another server 135, etc.) may perform the operations shown.

At 705, the process flow 700 may include receiving a first input at a model-building system, wherein the first input comprises patient data.

At 710, the process flow 700 may include receiving a second input at the model-building system, wherein the second input comprises medical claims data.

At 715, the process flow 700 may include receiving a third input at the model-building system, wherein the third input comprises third-party data.

At 720, the process flow 700 may include enabling the model-building system to leverage the first input, the second input, and the third input as part of building a prediction model for processing additional data from an entity that did not provide the patient data or the medical claims data.

At 725, the process flow 700 may include providing the prediction model to a prediction system that receives customer data and that feeds the customer data to the prediction model, wherein the prediction model is enabled to predict an outcome for a discrete date based on processing the customer data. In some aspects, the predicted outcome includes a temporal aspect.

A number of implementations have been described. Nevertheless, it will be understood that additional modifications may be made without departing from the scope of the inventive concepts described herein, and, accordingly, other examples are within the scope of the following claims.

The exemplary systems and methods of this disclosure have been described in relation to examples of a communication device 105 and a server 135. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the examples illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed examples, configuration, and aspects.

A number of variations and modifications of the disclosure can be used. It would be possible to provide for some features of the disclosure without providing others.

In yet another example, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another examples, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another example, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the examples with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various examples, configurations, and aspects, includes components, methods, processes, systems and/or apparatus substantially as depicted and described herein, including various examples, subcombinations, and subsets thereof. Those of skill in the art will understand how to make and use the systems and methods disclosed herein after understanding the present disclosure. The present disclosure, in various examples, configurations, and aspects, includes providing devices and processes in the absence of items not depicted and/or described herein or in various examples, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more examples, configurations, or aspects for the purpose of streamlining the disclosure. The features of the examples, configurations, or aspects of the disclosure may be combined in alternate examples, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed example, configuration, or aspect. Thus, the following claims are hereby incorporated into this Detailed Description, with each claim standing on its own as a separate preferred example of the disclosure.

Moreover, though the description of the disclosure has included description of one or more examples, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative examples, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an example that is entirely hardware, an example that is entirely software (including firmware, resident software, micro-code, etc.) or an example combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

What is claimed is:

1. A data pipeline, comprising:
an input that receives a first dataset representing categorical features and a second dataset representing numerical features;
a feature ingestion block that generates an output corresponding to a sum of the first dataset with the second dataset; and
an output that provides training labels based on a processing of the summed first dataset and second dataset to predict a temporally-isolated and discrete event.

2. The data pipeline of claim 1, further comprising a label creation block that receives the output from the feature ingestion block and generates labels for date features in the first dataset.

3. The data pipeline of claim 1, wherein:
the second dataset is discretized prior to being summed with the first dataset; and
discretizing the second dataset comprises converting numerical features of the second dataset into categorical features.

4. The data pipeline of claim 1, wherein:
the first dataset comprises categorical features from clinical data; and
the second dataset comprises numerical features from the clinical data.

5. The data pipeline of claim 1, wherein a model is used to predict the training labels.

6. The data pipeline of claim 5, wherein:
the model comprises a temporal axis and is configured to process discrete time steps; and
the training labels correspond to specific time steps in the discrete time steps, time windows associated with one or more of the specific time steps, or both.

7. A model pipeline, comprising:
one or more neural networks that:
receive a first input corresponding to a summation of non-learned date embedding with learned feature embedding; and
contextualize the summation of the non-learned date embedding with the learned feature embedding by date-embedding historical patient data into the summation of the non-learned date embedding with the learned feature embedding; and
a prediction block that receives the contextualized summation of the non-learned date embedding with the learned feature embedding and predicts one or more outcomes.

8. The model pipeline of claim 7, wherein the one or more neural networks comprise at least a feed-forward neural network that receives the first input.

9. The model pipeline of claim 7, wherein the one or more neural networks comprise at least a causal transformer neural network that contextualizes the summation of the non-learned date embedding with the learned feature embedding.

10. The model pipeline of claim 7, wherein the one or more neural networks maintain a temporal ordering of data associated with the contextualized summation of the non-learned date embedding with the learned feature embedding.

11. The model pipeline of claim 7, wherein:
the non-learned date embedding comprises feature dates with embedded dates; and
the learned feature embedding comprises feature codes with embedded features.

12. The model pipeline of claim 7, wherein:
the one or more outcomes comprise a plurality of outcomes; and
each of the plurality of outcomes has a different probability of likelihood.

13. The model pipeline of claim 7, wherein the one or more outcomes comprise a clinical outcome.

14. The model pipeline of claim 7, wherein the one or more outcomes comprise a retail outcome.

15. The model pipeline of claim 7, wherein the one or more outcomes comprise a temporal event.

16. A method, comprising:
receiving a first input at a model-building system, wherein the first input comprises patient data;
receiving a second input at the model-building system, wherein the second input comprises medical claims data;
receiving a third input at the model-building system, wherein the third input comprises third-party data;
enabling the model-building system to leverage the first input, the second input, and the third input as part of building a prediction model for processing additional data from an entity that did not provide the patient data or the medical claims data; and
providing the prediction model to a prediction system that receives customer data and that feeds the customer data to the prediction model, wherein the prediction model is enabled to predict an outcome for a discrete date based on processing the customer data.

17. The method of claim 16, wherein the predicted outcome comprises a temporal aspect.

18. A system comprising:
a model-building system; and
a prediction system,
wherein the model-building system is to:
receive a first input comprising patient data;
receive a second input comprising medical claims data;
receive a third input comprising third-party data;
leverage the first input, the second input, and the third input as part of building a prediction model for processing additional data from an entity that did not provide the patient data or the medical claims data; and
provide the prediction model to the prediction system; and
wherein the prediction system is to:
feed customer data to the prediction model; and
predict an outcome for a discrete date based on processing the customer data using the prediction model.

19. The system of claim 18, wherein:
the model-building system is to provide training labels to the prediction system; and
the prediction system is to evaluate the prediction model based on the outcome, using the training labels.

20. The system of claim 18, wherein the prediction system is to:
contextualize the customer data according to a temporal parameter; and
feed the contextualized customer data to the prediction model,
wherein predicting the outcome for the discrete date is based on processing the contextualized customer data using the prediction model.
